(19) United States
(12) Patent Application Publication
(10) Pub. No.: US 2020/0340661 A1
(43) Pub. Date: Oct. 29, 2020

(54) LIGHT FOR MARKING AN OBSTRUCTION OR A BEACON AND METHOD FOR ASSEMBLING SUCH A LIGHT

(71) Applicant: Orga Holding B.V., Schiedam (NL)

(72) Inventors: Pieter Gerardus GOEDKNEGT, Schiedam (NL); Johannes Arie DE BRUIJN, Schiedam (NL); Sai Cheung LAM, Schiedam (NL)

(21) Appl. No.: 16/606,341

(22) PCT Filed: Apr. 20, 2018
(86) PCT No.: PCT/NL2018/050249

§ 371 Date: Oct. 18, 2019

(30) Foreign Application Priority Data
Apr. 20, 2017 (NL) 2018757

(51) Int. Cl. F21V 31/00; F21V 3/00; F21V 23/00

(52) U.S. Cl. CPC F21V 31/005; F21W 2111/047; F21V 23/002; F21V 3/00

(57) ABSTRACT

A light for marking an obstruction or a beacon such as a buoy, the light comprising a light source; a light source support to which the light source is mounted; a housing in which the light source and the light source support are located, the housing being at least partially transparent for allowing light from the light source in the housing to pass through into an environment of the housing and having an open end bounding an opening; and a closure closing off the opening; wherein the closure comprises a lid member and a seal of a sealing material fully covering an outwardly facing side of the lid member and applied in a fluid form and solidified in the open end of the housing.

### FIELD AND BACKGROUND OF THE INVENTION

The invention relates to a light for marking an obstruction or a beacon such as a buoy and to a method for assembling such a light.

Obstacle lighting and lighting of marks for allowing safe navigation by aircraft and ships must be reliable, weather proof, e.g. up to degree of protection IP66, and robust, even in harsh environments while low maintenance requirements are important for keeping the total cost of ownership low. This of particular relevance in applications in which reaching the lighting units for repair or replacement is difficult, such as in obstacle lighting of wind turbines, which require climbers or cranes to reach the lighting units. Wind turbines that exceed 150 metres above ground level and 60 metres offshore generally need to be marked with obstacle lighting to ensure safe navigation of aviation around windfarms. Similar requirements apply to other high obstacles such as electricity masts, high rising buildings, radio towers and exposed pylons of mountain cable cars. Other examples of obstacle or marking lightings that are difficult to reach are lighting of off-shore structures and of buoys far away from a shore. In all such applications a long life-span, preferably equal to the full life span of the structure to which it is mounted so that no replacement is necessary during the life span of the structure, and a high reliability of lights are an important for keeping costs of ownership low.

### SUMMARY OF THE INVENTION

It is an object of the present invention to provide a light for marking an obstruction or a beacon, such as a buoy, which is particularly reliable for a long period of time and can be manufactured at low costs.

According to the invention, this object is achieved by providing a light according to claim 1.

A further object of the invention is to provide a method for assembling a light for marking an obstruction or a beacon, such as a buoy, which is particularly reliable for a long period of time and can be manufactured at low costs. This object is achieved by providing a method according to claim 14.

Because the closure includes a lid member and a seal of a sealing material fully covering an outwardly facing side of the lid member and applied in a fluid form and solidified in the open end of the housing, a particularly reliably sealed light is obtained which can be assembled in a simple manner using a small number of parts, a limited number of production steps and therefore very efficient and at low costs.

Advantageously, the housing has a trough or a rim surrounding the opening, the trough or rim adjacent an inner surface of the housing having a surface facing in upwards direction if the housing is in an orientation with its open end facing upwards and wherein the lid member has a flange extending along its periphery and projecting into the trough or towards the rim, preferably further comprising a sealing member, such as a sealing ring, in sealing contact with the trough or the rim and with the flange of the lid member. Thus, the lid member is reliably sealed against the housing when the sealing material for forming the seal is poured into the opening.

Advantageously, the sealing member forming the sealing ring is of a material applied onto the rim or into the trough in fluid form, preferably the fluid form of the sealing member/sealing ring material is an at least pasty, gelly form. This allows for a reliable and/or firm connection of the sealing ring to the housing.

Preferably, in the fluid form in which it is applied, the sealing material covering the lid member has a first viscosity, wherein, in the fluid form in which it is applied, the sealing member material has a second viscosity, the second viscosity being larger than the first viscosity. This may reduce the risk of inadvertent leaking and may allow for a more reliable and/or firm connection of the sealing ring to the housing.

More advantageously, the sealing material covering the lid member is a resin having optimal performance in the hard and/or severe environments in which the light may be positioned for operation. In particular a two-component thermo-hardened resin may have optimal performance.

Preferably, the lid member is part of the light source support, allowing easy and compact arrangement of the light source support in the housing as a single subassembly.

In operating condition, the open end of the housing is facing downwards. The housing thus extends over the seal and shields the seal against environmental influences.

Portions of the light source support may project through the seal covering the lid member to provide for mechanical elements or mounting elements for mounting the light. As such, the load transfer can be done via the mounting elements directly to the light source support, obviating or minimizing load transfer to the housing. Also load transfer to the seal may be minimized when using the load path via the mounting elements to the light source support.

Advantageously, at least a power supply cable or earth connection extends through the seal covering the lid member, thus by using a seal which is first poured and then hardened, a tight sealing connection around the power supply cable or earth connection can be obtained.

By providing the housing as a single, integrally formed part, a cost-effective housing can be obtained that both provides for the optical properties to allow the light rays to output from the light as well as for the receiving capacity to allow to receive the fluid sealing material. Also, the housing may be provided with cooperating elements, such as recesses, in which the sealing material can be poured that—after solidifying of the sealing material—provide for a firm mechanical connection, in addition to the preferably chemical or adhesive bonding of the sealing material with the housing, between the seal of the sealing material and the housing. The cooperating elements, preferably elongated recesses, can be oriented in axial direction and/or in circumferential direction at the inside of the housing at the part that is configured for receiving the fluid sealing material.

Particular elaborations and embodiments of the invention are set forth in the dependent claims.

Further features, effects and details of the invention appear from the detailed description and the drawings.

### BRIEF DESCRIPTION OF THE DRAWINGS

FIG. 1 is a perspective view of an example of a light according to the invention;

FIG. 2 is a bottom view of the light according to FIG. 1;

FIG. 3 is cross-sectional view along a plane in FIG. 2; and

FIG. 4 is a perspective view of a half of the light according to FIGS. 1-3 cut through along the plane in FIG. 2.

### DETAILED DESCRIPTION

It is to be noted that the figures are given by way of exemplary embodiments only. Corresponding elements are designated with corresponding reference numbers.

In the drawings, an example of a light for marking an obstruction or a beacon such as a buoy, according to the invention is shown. The light has two light sources 2, 2′, each including a LED 3, 3′ for emitting light when a suitably voltage is applied to the LED. The light sources 2, 2′ can be arranged for operating entirely of partially simultaneously or alternatingly or for operating successively, e.g. such that one of the LED's can start operating when the other one is defective or its light yield as decreased below an acceptable level. It is also possible to provide only a single LED or more than two LEDs and/or optics to suit lighting intensity and durability requirements.

The light sources 2, 2′ are mounted to a light source support 4, which in this example, includes circuit boards 10, 10′ carrying the light sources 2, 2′ and electronic components generally indicated by reference numbers 11, 11′. The light source support 4 also comprises shields 12, 13, 14 for shielding off light emitted in undesired directions. One or more of the shields 12, 13, 14 may also be in the form of a reflector reflecting, at least most of, that light in a desired range of directions. In some applications emitting light in all directions of for instance a half dome is desired. Shields are then preferably not provided. The light source support 4 also has support legs 15 to which the circuit boards 10. 10′ and an upper reflector shield 14 are mounted.

The light 1 further includes a housing 5 in which the light sources 2, 2′ and the light source support 4 are located. The housing 5 is transparent for allowing light from the light sources 2, 2′ in the housing 5 to pass through into an environment of the housing 5 and has an open end 9 bounding an opening 16. The housing 5 has a dome shaped upper portion, so that dirt is effectively washed off by rain and other precipitation. Although, for the sake of clarity, in the drawings lines hidden by the housing 5 are not shown, in the present example, the housing 5 is entirely of transparent material, e.g. plastic or glass. While transparent, the housing 5 may be have UV filtering properties to reduce exposure of internals of the housing to UV light, which would accelerate ageing of plastic materials.

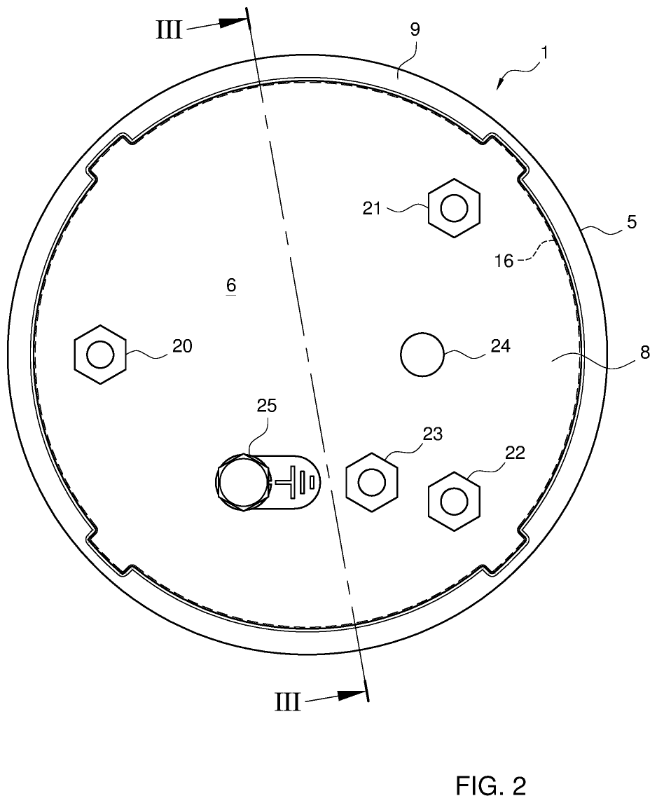

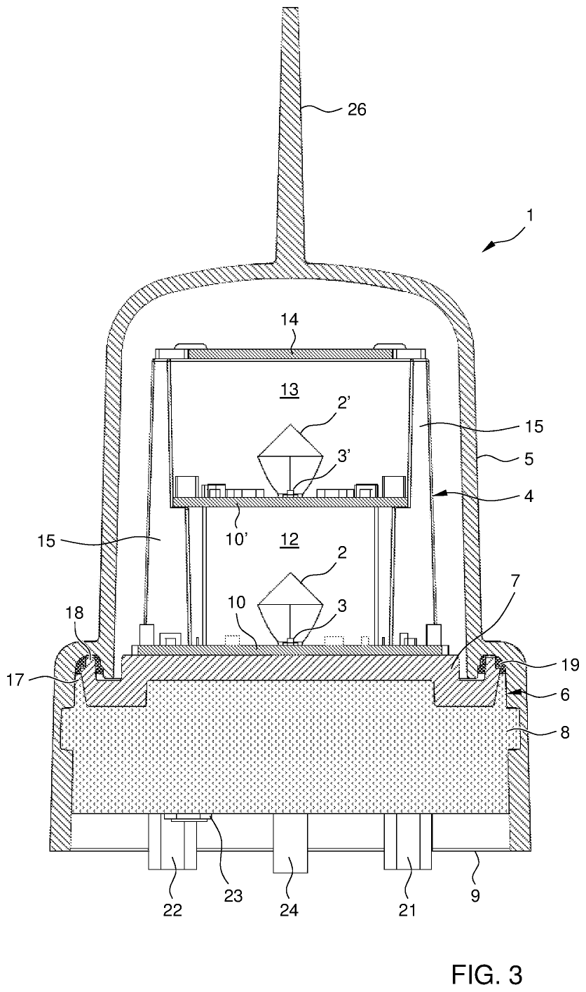

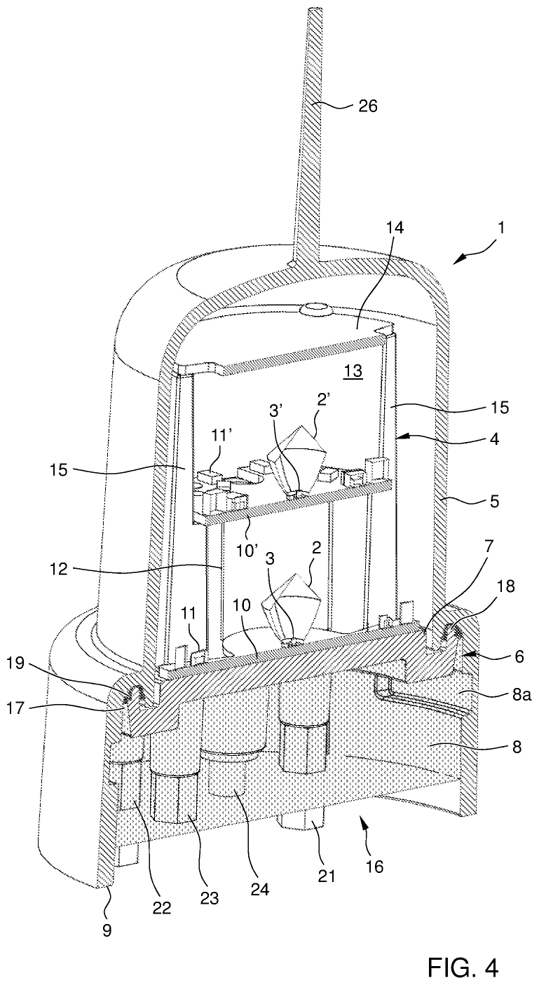

A closure 6 closes off the opening 16. The closure 6 includes a lid member 7 and a seal 8 of a sealing material fully covering an outwardly facing side of the lid member 7 and applied in a fluid form and solidified in the open end 9 of the housing 5. It is noted that for illustrative purposes, in FIGS. 2 and 3 the seal 8 is shown as a non-transparent member, while in FIG. 4 the seal 8 is shown as a transparent member.

Because the closure 6 includes a lid member 7 and a seal 8 of a sealing material fully covering an outwardly facing side of the lid member 7 and applied in a fluid form and solidified in the open end 9 of the housing 5, a particularly reliably sealed light 1 is obtained which can be assembled in a simple manner using a relatively small number of parts and in a small number of steps, so that the light 1 can be manufactured at low costs.

The seal may also contain all or a portion of the electronics, such as a power supply, which electronics are then shielded against environmental influences particularly effectively.

Assembling the light 1 can be carried out quickly by mounting the light source support 4 to which the light sources 2, 2′ are mounted into the housing 5, arranging the lid member 7 in the open end 9 of the housing 5, such that a flange portion of the open end 9 of the housing 5 projects beyond the lid member 7, holding the housing 5 in an orientation with the open end 9 facing upwards, pouring the sealing material in fluid form into the opening 16 until the lid member 7 is fully covered; and leaving the sealing material to solidify in the open end 9 of the housing 5 such that it covers the lid member 7. Only solidifying of the sealing material of the seal 8 may take some time, but this does not entail substantial costs. Hardening can be accelerated by speeding up curing or cooling, depending on the type of sealing material used.

Of the lid member 7 only an outwardly facing side is covered by the seal 8, so that the interior space of the light is not affected by optical properties of the material of the seal.

The lid member 7 and the housing 5 bound the interior space of the light 1 in which the light sources 2, 2′ and the light source support 4 are located. The lid member 7 has a circumferential end along its periphery extending towards the housing 5 and forming a body seam of the light 1. Since the seal 8 has a boundary surface at or in the body seam, the body seam is reliably sealed off, while it is avoided in a simple manner that seal material enters into the interior space of the light 1.

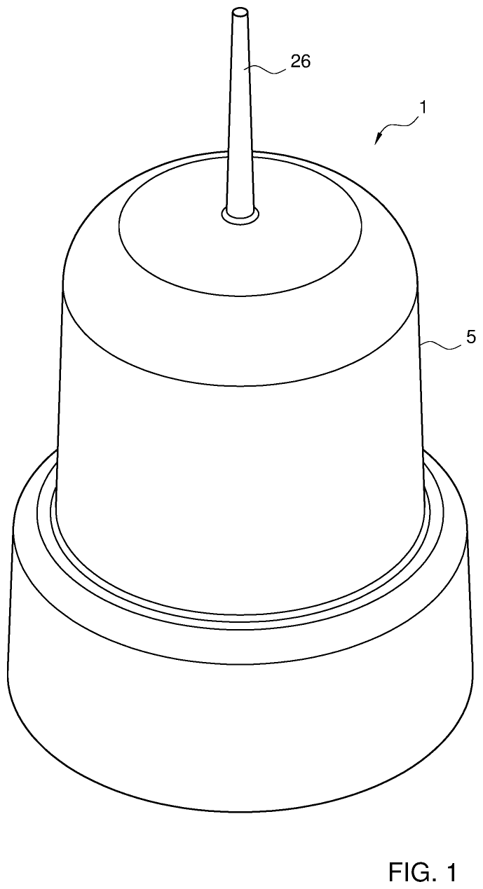

The housing 5 has a trough 17 surrounding the opening 16. The trough 17 has a surface facing in upwards direction if the housing 5 is in an orientation with its open end 9 facing upwards, i.e. upside down compared with the orientation shown in FIGS. 1, 3 and 4. Furthermore, the lid member 7 has a flange 18 extending along its periphery and projecting into the trough 17. The light 1 further includes sealing member such as a sealing ring 19 in sealing contact with the trough 17 and with the flange 18 of the lid member 7. Thus, the lid 7 is reliably sealed against the housing 5 when the sealing material for forming the seal 8 is poured into the opening 16 bounded by the open end 9 and onto the lid member 7, so that liquid sealing material for forming the seal 8 is reliably prevented from entering into the part of the housing 5 under the lid member 7.

Instead of a trough 17, a rim adjacent the inner surface of the housing and facing the open end can be provided, for instance in the form of a shoulder. The rim may be annular. The rim may be formed by a surface of a ring supported against notches on the inner surface of the housing.

During assembly, the sealing ring 19 may be arranged in position prior to the arranging of the lid member 7 in the open end 9 of the housing 5 and the flange 18 of the lid member 7 may then subsequently be brought in sealing contact with sealing ring 18 as the lid member 7 is arranged in the open end 9 of the housing 5.

For obtaining a particularly reliable sealing, the sealing ring 19 preferably applied onto the rim or into the trough 17 in fluid form.

The risk of inadvertent leaking of sealing ring material into the housing 5 is then reduced if the sealing ring material is an at least pasty, gelly form or has at least a larger viscosity than the viscosity of the material of the seal 8 as it is applied in fluid form. The sealing ring may for instance be in the form of a ring of an adhesive, such as a silicone adhesive/sealant supplied in paste form, a polyurethane adhesive or a flexible epoxy adhesive with sufficient filler material to be non-flowing between application, mounting of the lid and finally curing. The viscosity of the adhesive is preferably higher than 1000 mPa·s and more preferably higher than 1500 mPa·s at 20° C. and preferably lower than 3000 mPa·s and more preferably lower than 2500 mPa·s at 20° C.

The sealing material of the seal 8 covering the lid member 7 is preferably a resin. Such material is weather resistant and very durable. The resin may for instance be a two-component thereto-hardening resin, such as an epoxy resin, so that high temperatures that could adversely affect the light sources cabling and electronics are not required during assembly. More in particular, the resin may be a polyurethane resin/polybutadiene, polyurethane or epoxy casting compound. The viscosity at 20° C. of the sealing material of the seal during application is preferably more than 3000 mPa·s and more preferably less than 4000 mPa·s and preferably less than 10,000 mPa·s and more preferably less than 8000 mPa·s.

In the present example, the lid member 7 is part of the light source support 4. Thus, the light source support 4 including the lid member 7 can be arranged in the housing 5 as a single subassembly in one single operation.

Furthermore, in operating condition, the open end of the housing 5 is facing downwards. Thus, the resin of the seal 8 is shielded against weather and water can easily flow off the light 1, even though the seal does not completely fill up the housing up to the open end 9.

Because portions 20, 21, 22 of the light source support 4 project through the seal 8 covering the lid member 7, the light source support 4 can be mounted directly to the object or beacon without mechanical load transfer through the housing 5, so that the material of the housing 5 can be selected for optical properties, weather resistance and low costs, without much regard to long-term mechanical properties. In this example, portions 20, 21, 22 are in the form of support legs having threaded bores for bolting to a mounting base having apertures for bolts in a pattern matching the pattern of the bores. Ends of the support legs 20, 21, 22 are not round, so that rotation with bolts being tightened can be prevented by abutments on the mounting plate engaging the free ends of the support legs 20, 21, 22.

Also a power supply cable 24 and earth connections 23, 25 extend through the seal 8 covering the lid member 7, so that also the passage of the power supply cable 24 is reliably sealed as the material of the seal 8 is applied.

The housing 5 may be provided with cooperating elements, such as a recess 8a, in which the sealing material for forming the seal 8 can be poured that—after solidifying of the sealing material—provide for a firm mechanical connection between the seal 8 of the sealing material and the housing 5. The cooperating element, here an elongated recess 8a, is here oriented in circumferential direction at the inside of the housing 5 at the part that is configured for receiving the fluid sealing material. The cooperating element can also be oriented alternatively and/or additionally in axial direction.

The housing 5 is a single, integrally formed part, which further reduces manufacturing costs and is advantageous for obtaining a reliably sealed light 1. K as in the present example, the entire housing 5 is of transparent material, light sensor can for instance easily be arranged in the housing for receiving light from the environment. The signal from the sensor can for instance be used as an input signal for activating the light sources only if it is not sufficiently light (i.e. only at night or in adverse weather conditions) and/or to monitor whether the light sources are emitting light. Also other sensors and receivers can be arranged in the housing such as GPS signal receivers for receiving time signals on the basis of which operation of flashing of the light sources can be controlled. If these or other electronic components are cast-in in the seal covering the lid, the components are protected against environmental influences particularly effectively. In this example, the housing has an upwardly projecting bird spike 26, for discouraging birds from positioning themselves on the housing 5 and littering the light.

The lifetime of the light source or set of light sources in the housing is preferably at least 25 years. After such a period of time an obstacle such as a wind turbine has typically reached the end of its life span, so that it is no disadvantage that the light cannot be disassembled for replacing the light sources. Also the costs of a light according to the invention can be so low that it is then more economical to replace the entire unit (including the by then weathered housing) than to replace the light source only.

For the purpose of clarity and a concise description, features are described herein as part of the same or separate embodiments, however, it will be appreciated that the scope of the invention may include embodiments having combinations of all or some of the features described. It may be understood that the embodiments shown have the same or similar components, apart from where they are described as being different.

Several features have been described as part of the same or separate embodiments. However, it will be appreciated that the scope of the invention also includes embodiments having combinations of all or some of these features other than the specific combinations of features embodied in the examples.

1. A light for marking an obstruction or a beacon, the light comprising:
a light source;
a light source support to which the light source is mounted;
a housing in which the light source and the light source support are located, the housing being at least partially transparent for allowing light from the light source in the housing to pass through into an environment of the housing and having an open end bounding an opening; and
a closure closing off the opening;
wherein the closure comprises a lid member and a seal of a sealing material fully covering an outwardly facing side of the lid member and applied in a fluid form and solidified in the open end of the housing.

2. The light according to claim 1, wherein the housing has a trough or a rim surrounding the opening, the trough or rim adjacent an inner surface of the housing having a surface facing in upwards direction upon the housing being oriented in an orientation with its open end facing upwards and wherein the lid member has a flange extending along its periphery and projecting into the trough or towards the rim, and further comprising a sealing member in sealing contact with the trough or the rim and with the flange of the lid member.

3.-5. (canceled)

6. The light according to claim 1, wherein the sealing material covering the lid member is a resin.

7. The light according to claim 1, wherein, of the lid member, only an outwardly facing side is covered by the seal.

8. The light according to claim 1, wherein the lid member and the housing bound an interior space of the light, the lid member having a circumferential end along its periphery extending towards the housing and forming a body seam of the light and wherein the seal has a boundary surface at or in said body seam.

9. The light according to claim 1, wherein the lid member is part of the light source support.

10. The light according to claim 1, wherein, in operating condition, the open end of the housing is facing downwards.

11. The light claim 1, wherein portions of the light source support project through the seal covering the lid member.

12. The light according to claim 1, wherein at least a power supply cable or earth connection extends through the seal covering the lid member.

13. The light according to claim 1, wherein the housing is a single, integrally formed part.

14. A method for assembling a light for marking an obstruction or a beacon, the method comprising:
providing:
a light source;
a light source support to which the light source is mounted;
a housing which is at least partially transparent for allowing light to pass through from inside the housing to an environment of the housing, the housing having an open end bounding an opening;
a lid member; and
a sealing material;
mounting the light source support to Which the light source is mounted into the housing;
arranging the lid member in the open end of the housing, such that a flange portion of the open end of the housing projects beyond the lid member;
holding the housing in an orientation with the open end facing upwards;
pouring the sealing material in fluid form into the opening until the lid member is fully covered; and
leaving the sealing material to solidify in the open end of the housing such that it covers the lid member.

15. The method according to claim 14, wherein prior to the arranging of the lid member in the open end of the housing, such that a flange portion of the open end of the housing projects beyond the lid member, a sealing member is arranged in a trough or on a rim, the trough or rim surrounding an opening bounded by the open end and the lid member has a flange extending along its periphery which is brought in sealing contact with sealing member as the lid member is arranged in the open end of the housing.

16. The method according to claim 15, wherein the sealing member is applied in fluid form, the fluid form being pasty or gelly.

17. The method according to claim 16, wherein, during application of the sealing member in the fluid form, the sealing material covering the lid member has a first viscosity, and wherein, upon solidification, the sealing member material has a second viscosity, the second viscosity being larger than the first viscosity.

18. The light according to claim 2, wherein, of the lid member, only an outwardly facing side is covered by the seal.

19. The light according to claim 2, wherein the lid member and the housing bound an interior space of the light, the lid member having a circumferential end along its periphery extending towards the housing and forming a body seam of the light and wherein the seal has a boundary surface at or in said body seam.
